(19) United States
(12) Patent Application Publication
(10) Pub. No.: US 2020/0114400 A1
(43) Pub. Date: Apr. 16, 2020

(54) Cleaning Multi-Stage Centrifugal Pumps

(71) Applicant: Franklin Dale Henson, Friendswood, TX (US)

(72) Inventor: Franklin Dale Henson, Friendswood, TX (US)

(21) Appl. No.: 16/157,311

(22) Filed: Oct. 11, 2018

(51) Int. Cl. B08B 3/12; F04D 1/06; B08B 3/08

(52) U.S. Cl. CPC B08B 3/12; F04D 1/06; E21B 41/00; B08B 2203/007; B08B 3/08

(57) ABSTRACT

Multistage centrifugal pumps are cleaned using ultrasonic energy and without disassembling the pump. The system can be at a permanent installation where the pump is brought for cleaning. The fully assembled pump is submerged in a tank of fluid and cleaning solution is circulated through the pump while ultrasonic energy is applied to the tank. Alternately, a portable pump cleaning system is taken to the site where the pump is working, such as a well site. The pump is cleaned by circulating a cleaning fluid through the pump while ultrasonic energy is applied to the pump housing. Still further, ultrasonic energy may be applied to the pump housing while it continues to pump a working fluid. Flow resistance through the pump is monitored to determine when the cleaning process is complete. In all three applications, disassembly of the pump is unnecessary, providing a major savings in time and money.

### FIELD OF THE INVENTION

The present invention relates to submersible pumps and, more particularly but without limitation, to cleaning multi-stage centrifugal pumps.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate a preferred embodiment of the invention and are not to be construed as limiting the scope of the invention.

FIG. 1 is an illustration of a typical multistage centrifugal pump.

FIG. 2 is illustrates a typical surface assembly for an operating multistage centrifugal pump.

FIG. 3 is a schematic illustration of a pump cleaning system according to a first preferred embodiment of the present invention for use at a pump cleaning facility.

FIG. 4 is a schematic illustration of a portable pump cleaning system according to a second preferred embodiment of the present invention for use on location at the well site.

FIG. 5 is a schematic illustration of a pump cleaning system in accordance with a third preferred embodiment of the present invention for use on an operating pump as it continues to pump a working fluid.

### DETAILED DESCRIPTION OF THE PREFERRED EMBODIMENT(S)

Multi-stage centrifugal pumps are widely used in the oilfield for both surface and downhole applications. Downhole pumps are used to produce petroleum and water found in a geologic formation. In many cases, the pumped liquid is high in dissolved solids and other substances that precipitate or otherwise become deposited on the interior surfaces of the pump, impeding flow and reducing pump efficiency.

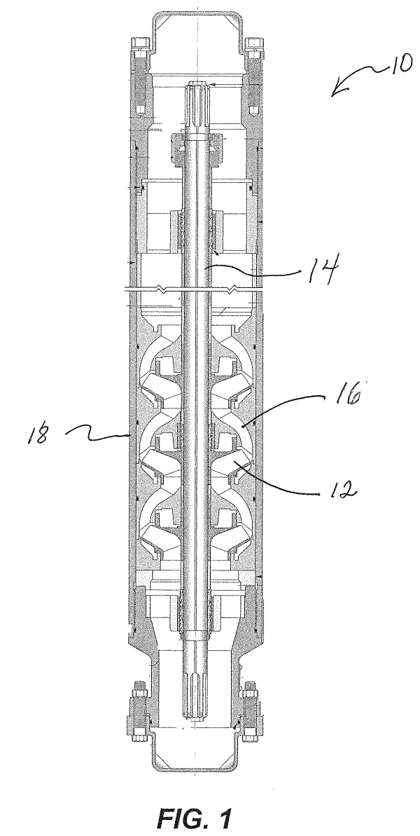

A typical pump, one of which is illustrated in FIG. 1 and designated by the reference number 10, may be between 5 and 30 feet long, and 3 to 10 inches or more in diameter. The pump 10 comprises multiple spinning impellers designated collectively at 12 and that are mounted on a motor-driven shaft, each impeller 12 alternating with stationary diffusers designated collectively at 14, all held in a cylindrical housing 16.

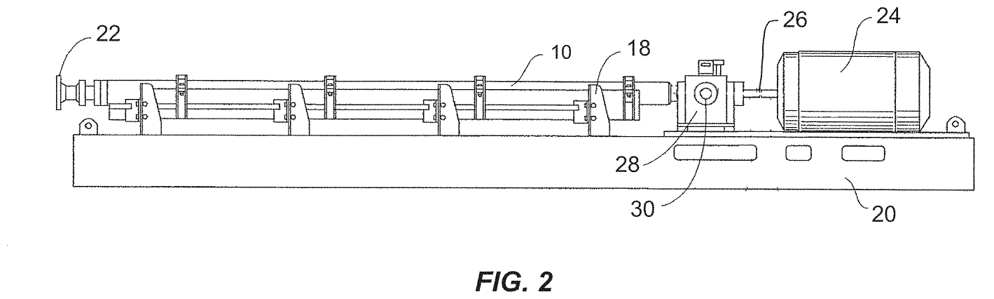

Pumps used in downhole applications may be installed in a wellbore to lift petroleum-bearing fluid and water to the surface. Pumps may be used in various surface applications. When used in a surface application, the pump 10 typically is mounted horizontally in a cradle 18 supported on a framework or platform such as a skid 20, as shown in FIG. 2. The pump 10 has a discharge 22 on one end that connects to the outgoing flow line (not shown). The pump 10 is driven by a separate prime mover, such as an electric motor 24, coupled to the pump by a shaft 26 that extends through a thrust chamber 28 with an intake 30 that connects to an incoming flow line (not shown). It is common for these pumps to be used to transport water from producing wells or to pump waste water into water disposal wells.

Whether operating downhole or at the surface, these pumps frequently become plugged with scale or deposits of varying types, such as paraffin, asphaltenes, or other substances. These deposits are referred to herein collectively as “contaminants.” Conventionally, cleaning of submersible pumps involves removing the pump from the well or the frame at the well site and transporting it to a pump cleaning facility. In most instances, the pump is dismantled and the individual components are cleaned separately, usually using steam or chemicals or both.

This present invention provides a system and method that effectively cleans centrifugal pumps using ultrasonic energy without having to disassemble the pump. This can be done at a pump cleaning facility or at the well site and can even be carried out while a surface pump is still operating on site. It will be appreciated that the present invention may be applied to any type of pump or flow management device that is amenable to ultrasonic cleaning.

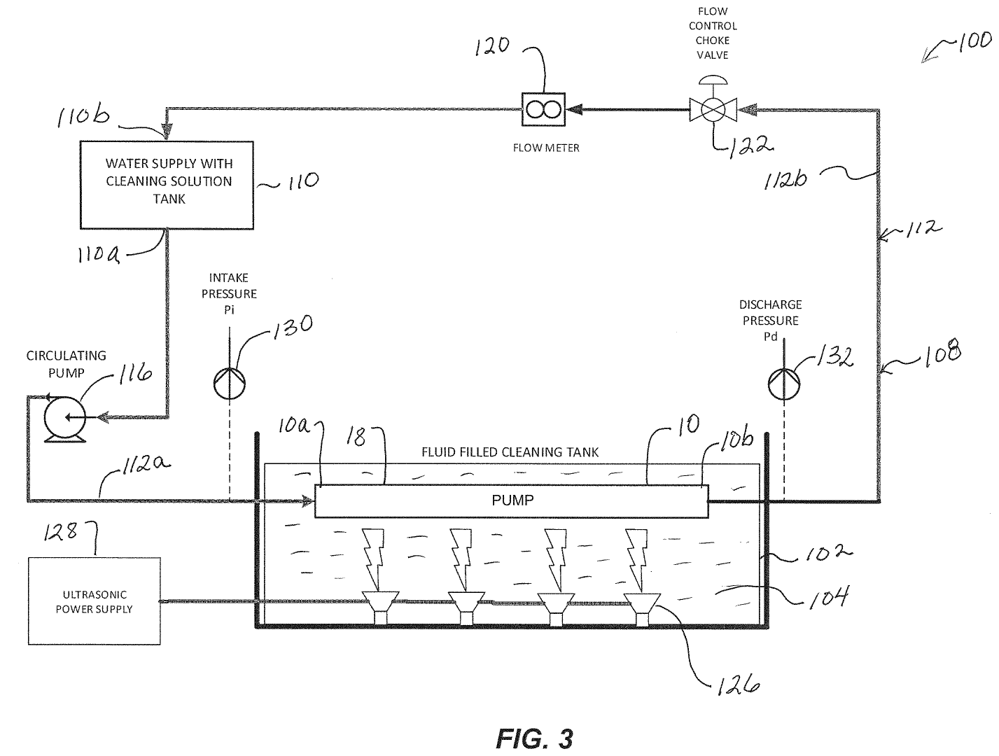

In one embodiment, the pump is transported to a cleaning facility. An exemplary cleaning system is illustrated in FIG. 3 and designated generally by the reference number 100. Without disassembling the pump 10, it is placed in a vat or tank 102 sized to contain the pump submerged in a volume of fluid 104, such as water.

A cleaning solution (not shown) may also be circulated through the pump 10 to facilitate cleaning the pump inside and outside. By way of example, the cleaning fluid may comprise a solution of water and surfactants, corrosion inhibitors, solvents, or other cleaning substances, which assist the ultrasonic system to remove contaminants from both the inside and outside of the pump 10. To that end, the system 100 may further comprise a cleaning fluid circuit 108.

The cleaning fluid circuit may comprise a reservoir 110 of cleaning fluid and an assembly of pipes or other conduits forming a cleaning conduit 112 to form a closed loop between the reservoir 110 and the pump 10 for continuously circulating the cleaning solution repeatedly through the pump 10. More specifically, the first section 112a of the cleaning conduit 112 fluidly connects the inlet end 10a of the pump 10 with the outlet 110a of the reservoir 110. A second section 112b of the cleaning conduit 112 connects the outlet 10b of the pump 10 with the inlet 110b of the reservoir 110.

A circulating pump 116 is included for driving the cleaning fluid through the cleaning circuit 112. Thus, the cleaning fluid flows through the pump 10 being passively driven by the exterior circulating pump 116; the impellers 12 in the pump 10 are not pumping fluid through the housing 18 (FIG. 1) as they would when the pump is working. A flow meter 120 and a flow control choke valve 122 may be included in the cleaning circuit 112. The type and location in the circuit 112 of the flow meter may vary, so long as it is fluidly coupled to the pump for measuring the flow rate of the fluid through the pump.

In a closed loop system as shown in FIG. 3, a finite amount of cleaning solutions is continuously recirculated in the cleaning circuit 112. It may be beneficial to include a filter, settling tank, or other device (not shown) for removing the contaminants from the solution.

Still further, in some cases, it is advantageous to heat the cleaning fluid as this may enhance the effect of the ultrasonic waves. To that end, a heating element may be provided in the tank 102, or the cleaning circuit 112 may include heat exchanger or other means for heating the fluid.

Having installed the pump 10 inline in the cleaning circuit 112, ultrasonic energy is applied to the fluid in the tank using at least one ultrasonic transducer configured to direct ultrasonic waves at the pump while the pump is filled with fluid to produce cavitation in the fluid in the pump 10. In the embodiment illustrated in FIG. 3, several transducers 126 are mounted in the cleaning tank 102. Although the array of transducers 126 shown includes four (4) horizontally aligned units, the number, type, and configuration of the transducers may vary.

The transducers 126 are electrically connectable to a suitable power supply 128. When the transducers 126 are energized, ultrasonic energy from the transducers in the tank 102 is coupled through the water 104 and the metal pump housing 18 (FIG. 1) into the interior of the pump 10 filled with cleaning fluid, where it causes cavitation bubbles and produces the cleaning action.

Progress of the cleaning process is monitored by repeatedly determining flow resistance inside the pump 10. In the exemplary system 100, resistance is determined by measuring the pressure differential in the cleaning fluid flowing through the pump 10 and the flow rate of the fluid and calculating the resistance a ratio of pressure differential to flow rate. For that purpose, the system 100 may comprise inlet and outlet pressure sensors 130 and 132 connectable to the conduits 112a and 112b near the inlet and outlet ends 10a and 10b, respectively, of the pump 10.

Differential pressure across the pump 10 is represented by the following formula:

ΔP=P_{d}−Pᵢ

where ΔP is differential pressure, P_{d} is discharge pressure at the sensor 132 and Pᵢ is the intake pressure at the sensor 130. As the cleaning operation gradually removes the scale and other deposits on the inside of the pump 10, the resistance to flow will decrease and eventually remain relatively constant. When resistance stops decreasing and remains constant, the cleaning is complete. As used herein, “remains constant” is not used in an absolute sense; rather, it denotes a series of repeated measurements with only minor variations that indicate further cleaning is unnecessary, that is, not likely to produce significantly lower resistance levels.

Having described an illustrative system, an embodiment of the inventive method well be explained. First the pump 10 is connected to the cleaning circuit 112 and submerged in the tank 102 which is filled with water or other fluid. Once connected, the cleaning fluid is circulated through the pump by the circulating pump 116. The choke valve 122 is adjusted to achieve a desired flow rate as measured by the flow meter 120. While cleaning fluid is in the pump 10, ultrasonic waves are directed at the pump 10 using the transducers 126 to produce cavitation in the fluid in the pump.

In some embodiments of the invention, the circulating pump 116 is operated intermittently to produce alternating flow periods and static periods in the circulating cleaning fluid. The flow resistance is measured during the flow periods. The transducers 126 may be operated continuously or intermittently. In some embodiments, the transducers 126 are operated during the static periods. Operating the transducers 126 during static periods may produce superior cavitation and thus improved cleaning. The intermittent flow periods permit monitoring of the improved flow through the pump (decreased resistance) and also sweeps or flushes the loosened debris out of the pump 10.

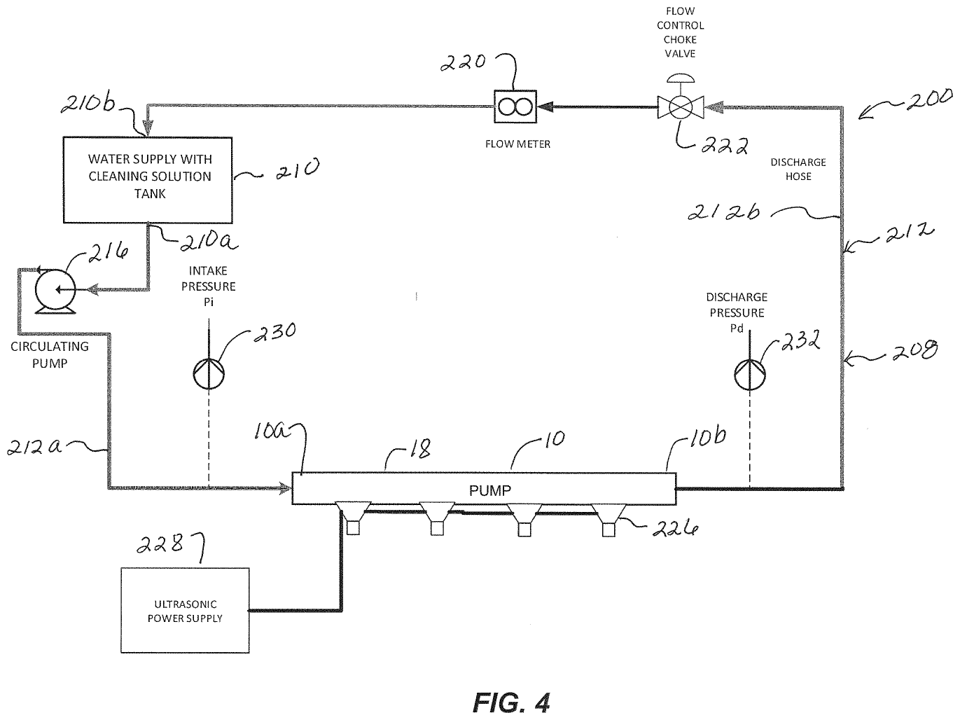

Turning now to FIG. 4, another embodiment of the present invention will be described. FIG. 4 illustrates the system and method of the present invention conducted on location at the well site where the pump 10 has been disconnected from its usually pumping operation (FIG. 2) and connected instead to the inventive system designated generally by the reference number 200. In this embodiment, the pump 10 may be mounted on a frame of some sort (not shown) or on the conventional frame 20 in the case of a pump operating above ground. That is, the cleaning tank 102 of the previous embodiment may be omitted in on-site system 200.

As in the previously described system 100, a cleaning solution (not shown) is circulated through the pump 10 to facilitate cleaning the pump inside and outside. Thus, the system 200 may further comprise a cleaning fluid circuit 208. The cleaning fluid circuit may comprise a reservoir 210 of cleaning fluid and an assembly of pipes or other conduits forming a cleaning conduit 212 to form a closed loop between the reservoir 210 and the pump 10. More specifically, the first section 212a of the cleaning conduit 212 fluidly connects the inlet end 10a of the pump 10 with the outlet 210a of the reservoir 210. A second section 212b of the cleaning conduit 212 connects the outlet 10b of the pump 10 with the inlet 210b of the reservoir 210.

A circulating pump 216 is included for driving the cleaning fluid through the cleaning circuit 212. Thus, the cleaning fluid flows through the pump 10 being passively driven by the exterior circulating pump 216 as in the previous embodiment. A flow meter 220 and a flow control choke valve 222 may be included in the cleaning circuit 212.

Having installed the pump 10 inline in the cleaning circuit 212, ultrasonic energy is applied to the cleaning fluid in the pump 10 using at least one ultrasonic transducer configured to direct ultrasonic waves at the pump while the pump is filled with fluid to produce cavitation in the fluid in the pump. In this embodiment, several transducers 226 are mounted removably on the exterior of the pump housing 18. For example, the array of transducers 226 may be clamped to the pump 10.

The transducers 226 are electrically connectable to a suitable power supply 228. When the transducers 226 are energized, ultrasonic energy from the transducers clamped to the pump housing 18 is transmitted to the cleaning fluid inside the pump, where it causes cavitation bubbles and produces the cleaning action.

As before, progress of the cleaning process is monitored by repeatedly determining flow resistance inside the pump 10. In the exemplary system 200, resistance is determined by measuring the pressure differential and flow rate in the cleaning fluid flowing through the pump 10. For that purpose, the system 200 may comprise inlet and outlet pressure sensors 230 and 232 connectable to the conduits 212a and 212b near the inlet and outlet ends 10a and 10b, respectively, of the pump 10, and a flow meter 220.

The pressure differential is monitored to determine when the flow resistance stops decreasing, at which point the cleaning operation is terminated, the pump is disconnected from the system conduits 212 and reconnected to the intake and discharge lines at the site to continue its normal operation. Now it will be appreciated that the pump 10 in an above-ground setting can be connected to the inventive system 200 and cleaned without even removing it from the conventional pump framework on site. The mounting of the components of the system 200—the conduits, circulating pump, cleaning fluid reservoir, etc., may be mounted on a mobile platform and moved from location to location as needed. This substantially reduces the time the pump 10 is out of service.

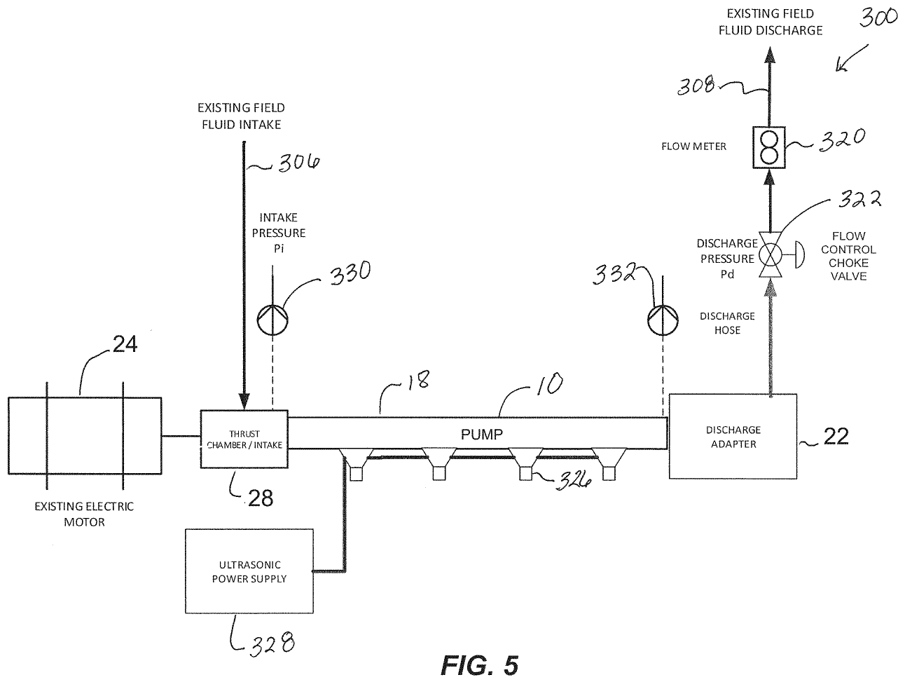

In yet another embodiment, illustrated in FIG. 5, the system and method of the present invention is used to perform the cleaning operation without removing the pump 10 from service. Instead, the pump is cleaned while operating in its normal working installation and without interfering with the pump's normal operation. For example, in the case of a surface pump that is pumping waste water into a water disposal well, the “working fluid,” as that term is used herein, refers to the waste water being pumped. In other words, in this embodiment, no cleaning solution is used; instead the medium for conducting the ultrasound is the waste water or other working fluid that is being pumped at the site. This embodiment may be effective in prevention of additional deposition of scale.

As shown in FIG. 5, the inventive system is designated generally by the reference number 300. In this embodiment, the pump 10 remains mounted on its skid 20 (FIG. 2). Additionally, the pump 10 remains connected to the pump end assembly such as the thrust chamber 28 and the motor 24 (FIG. 2) that drives the pump 10. The pump 10 also remains connected inline between the incoming flow line 306 and the outgoing flow line 308 through the discharge 22 (FIG. 2). As in the immediately preceding embodiment, the cleaning tank is omitted. In this embodiment, the use of a cleaning solution also is eliminated, so the circulating pump, cleaning fluid reservoir, and cleaning conduit also are omitted. In this embodiment, the pump 10 being cleaned is also the force driving the fluid—the working fluid—through the pump.

In most instances, the flow of working fluid through the pump may be regulated by the existing flow control devices in the field system. A flow meter 320 and a flow control choke valve 322 may be included in the system 300.

As in the immediately preceding embodiment, an array of transducers 326 is mounted removably on the exterior of the pump housing 18. For example, the array of transducers 326 may be clamped to the pump 10. Alternately, a dedicated transducer array may be mounted to the pump 10 for permanent or semi-permanent installation. This allows regular, periodic cleaning.

The transducers 326 are electrically connectable to a suitable power supply 328. When the transducers 326 are energized, ultrasonic energy from the transducers 326 clamped to the pump housing 18 is transmitted to the working fluid inside the pump, where it causes cavitation bubbles and produces the cleaning action.

As before, progress of the cleaning process is monitored by repeatedly determining flow resistance inside the pump 10. In the exemplary system 300, resistance is determined by measuring the pressure differential in the cleaning fluid flowing through the pump 10. For that purpose, the system 300 may comprise inlet and outlet pressure sensors 330 and 332 connectable at the inlet and outlet ends 10a and 10b, respectively, of the pump 10.

The pressure differential and flow rate are monitored to determine when the flow resistance stops decreasing, at which point the cleaning operation is terminated. It will also be understood now that intermittent operation of the pump 10 to produce alternating flow periods and static periods, as previously described, may be controlled by the existing or field controls (not shown). Now it will be appreciated that the pump 10 in an above-ground setting can be connected to the inventive system 300 and cleaned without removing it from service. The working fluid is used to conduct the ultrasonic energy inside the pump housing 18.

Now it will be apparent that the present invention, in addition to providing an ultrasonic cleaning method for submersible pumps, also provides a method for continuously monitoring the effectiveness of the cleaning process. The tortuous fluid path through these pumps creates a resistance to flow. This resistance is increased proportionally as scale and other contaminants are deposited inside the pump. Conversely, as contaminants are removed by the ultrasonic cleaning process, the resistance to flow will decrease. This invention includes the monitoring of flow resistance in the pump by comparing the relative pressure required to obtain a given flow rate through the pump.

The embodiments shown and described above are exemplary. Many details are often found in the art and, therefore, many such details are neither shown nor described herein. It is not claimed that all of the details, parts, elements, or steps described and shown herein are newly invented. Changes may be made in the details, especially in matters of shape, size, and arrangement of the parts, within the principles of the invention to the full extent indicated by the broad meaning of the terms in the attached claims. The description and drawings of the specific embodiments herein do not point out what an infringement of this patent would be, but rather provide non-limiting examples of how to use and make the invention. Likewise, the abstract is neither intended to define the invention, which is measured by the claims, nor is it intended to be limiting as to the scope of the invention in any way. The limits of the invention and the bounds of the patent protection are measured by and defined in the following claims.

What is claimed is:

1. A method for cleaning a multistage centrifugal pump, the method comprising:
circulating a fluid through the pump; and
directing ultrasonic waves at the pump while the pump is filled with fluid to produce cavitation in the fluid in the pump.

2. The method of claim 1 wherein the fluid circulated through the pump is cleaning fluid and wherein the step of circulating the cleaning fluid through the pump comprises driving the cleaning fluid through the pump using a circulating pump.

3. The method of claim 2 further comprising:
submerging the pump in a fluid contained in a cleaning vessel; and
wherein the step of directing ultrasonic waves at the pump while the pump is filled with fluid to produce cavitation in the fluid in the pump is carried out by mounting ultrasonic transducers in the cleaning vessel.

4. The method of claim 3 wherein the fluid in the cleaning vessel is water.

5. The method of claim 3 wherein the step of circulating the cleaning fluid through the pump further comprises circulating the cleaning fluid through the pump intermittently to produce alternating flow periods and static periods.

6. The method of claim 5 further comprises:
repeatedly determining flow resistance inside the pump; and
discontinuing the cleaning operation when the flow resistance remains constant.

7. The method of claim 6 wherein the step of repeatedly determining flow resistance inside the pump is carried out by repeatedly determining the pressure differential and flow rate across the pump during flow periods and calculating the resistance as a ratio of pressure differential to flow rate.

8. The method of claim 2 wherein the step of directing ultrasonic waves at the pump while the pump is filled with fluid to produce cavitation in the fluid in the pump is carried out by mounting ultrasonic transducers to the pump.

9. The method of claim 8 wherein the step of circulating the cleaning fluid through the pump further comprises circulating the cleaning fluid through the pump intermittently to produce alternating flow periods and static periods.

10. The method of claim 9 further comprising:
repeatedly determining flow resistance inside the pump; and
discontinuing the cleaning operation when the flow resistance remains constant.

11. The method of claim 10 wherein the step of repeatedly determining flow resistance inside the pump is carried out by repeatedly determining the pressure differential and flow rate across the pump during flow periods and calculating the resistance as a ratio of pressure differential to flow rate.

12. The method of claim 1 wherein the fluid circulated through the pump is working fluid and wherein the step of circulating the cleaning fluid through the pump comprises operating the pump.

13. The method of claim 12 wherein the step of directing ultrasonic waves at the pump while the pump is filled with fluid to produce cavitation in the fluid in the pump is carried out by mounting ultrasonic transducers to the pump.

14. The method of claim 13 wherein the step of circulating the working fluid through the pump further comprises circulating the working fluid through the pump intermittently to produce alternating flow periods and static periods.

15. The method of claim 14 further comprising:
repeatedly determining flow resistance inside the pump; and
discontinuing the cleaning operation when the flow resistance remains constant.

16. The method of claim 15 wherein the step of repeatedly determining flow resistance inside the pump is carried out by repeatedly determining the pressure differential and flow rate across the pump during flow periods and calculating the resistance as a ratio of pressure differential to flow rate.

17. The method of claim 1 wherein the step of circulating the fluid through the pump further comprises circulating the fluid through the pump intermittently to produce alternating flow periods and static periods.

18. The method of claim 17 further comprising:
repeatedly determining flow resistance inside the pump; and
discontinuing the cleaning operation when the flow resistance remains constant.

19. The method of claim 18 wherein the step of repeatedly determining flow resistance inside the pump is carried out by repeatedly determining the pressure differential and flow rate across the pump during flow periods and calculating the resistance as a ratio of pressure differential to flow rate.

20. The method of claim 17 wherein the step of directing ultrasonic waves at the pump while the pump is filled with fluid to produce cavitation in the fluid in the pump is carried out during flow periods.

21. The method of claim 20 wherein the step of directing ultrasonic waves at the pump while the pump is filled with fluid to produce cavitation in the fluid in the pump is carried out only during flow periods.

22. The method of claim 2 wherein the step of circulating the cleaning fluid through the pump includes continuously circulating the cleaning fluid through a closed loop fluid circuit and wherein the method further comprises removing contaminants from the cleaning fluid downstream of the pump.

23. A system for cleaning a multi-stage centrifugal pump, the system comprising:
at least one ultrasonic transducer configured to direct ultrasonic waves at the pump while the pump is filled with fluid to produce cavitation in the fluid in the pump;
a flow meter fluidly coupled to the pump for measuring flow rate of the fluid through the pump; and
inlet and outlet pressure sensors connectable to the inlet and outlet of the pump.

24. The system of claim 23 further comprising:
a reservoir of cleaning fluid;
a cleaning conduit configured to create a cleaning fluid circuit for circulating cleaning fluid between the centrifugal pump and the reservoir of cleaning fluid;
a circulating pump for driving the cleaning fluid through the cleaning circuit.

25. The system of claim 24 wherein the at least one ultrasonic transducer is mountable on the centrifugal pump.

26. The system of claim 24 further comprising:
a cleaning tank sized to contain the centrifugal pump and a volume of cleaning fluid; and
wherein the at least one ultrasonic transducer is mountable in the cleaning tank.

27. The system of claim 24 wherein the at least one ultrasonic transducer is mountable in the cleaning tank.

28. The system of claim 23 wherein the at least one ultrasonic transducers comprises a plurality of ultrasonic transducers.
